(19) United States
(12) Patent Application Publication
(10) Pub. No.: US 2010/0024662 A1
(43) Pub. Date: Feb. 4, 2010

(54) ROTATABLE WAFFLE MAKER

(75) Inventors: ALAN D. BENGTSON, SAINT JOSEPH, MI (US); MICHAEL K. PATTON, SAINT JOSEPH, MI (US); ROSARIO CIANCIMINO, BERRIEN SPRINGS, MI (US); JOHN B. LEDINGHAM, SANTA CRUZ, CA (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/181,362

(22) Filed: Jul. 29, 2008

(51) Int. Cl. A47J 37/06

(52) U.S. Cl. 99/377

(57) ABSTRACT

A waffle maker comprises a grill that is rotatable with respect to a base about a rotational axis.

### BACKGROUND OF THE INVENTION

1. Field of the Invention

This invention generally relates to waffle makers, and particularity to rotatable waffle makers.

2. Description of the Related Art

Waffle makers are commonly used and come in several types A common type of waffle maker, also referred to as waffle irons or waffle bakers, has a clamshell-type baking chamber with opposing grill plates that are hingedly connected together, including a stationary bottom plate and a pivoting top plate that can be selectively closed over the bottom plate. To make a waffle, batter is poured onto the bottom plate and the top plate is closed such that both sides of the batter are cooked simultaneously.

Some waffle makers are known that have a rotating feature whereby the baking chamber rotates approximately 180° about the centerline of the waffle maker after being loaded with batter. Rotation of the baking chamber provides more uniform filling of the both sides of the baking chamber, thus yielding a more consistent baking performance than the typical non-rotating waffle makers.

While the rotating feature of professional waffle makers enhance the baking performance, they tend to have a much greater height and bulk to permit the rotation, which makes them relatively more expensive and bulky. In some kitchens, the bulkiness is sufficient enough that the waffle maker cannot be stored in a cabinet and must be left on the countertop, which is undesirable to many consumers. Therefore, a waffle maker is needed that is able to rotate without having the disadvantages associated with typical rotating waffle makers.

### SUMMARY OF THE INVENTION

A waffle maker according to the present invention comprises a base and a grill having a body centerline and rotatably mounted to the base for rotation about a rotational axis, wherein at least one point on the body centerline is radially offset from at least one point on the rotational axis.

The body centerline can be parallel to the rotational axis. The grill can have a geometric centerline that is collinear with the body centerline. The grill can be rotatable about the rotational axis between a first and a second rotational position to define a range of motion. The body centerline can remain parallel to the rotational axis throughout the range of motion. The grill can be in a substantially horizontal orientation in the first and second rotational positions.

The grill can be rotatable about the rotational axis between a first and a second rotational position. The grill can be in a substantially horizontal orientation in the first and second rotational positions. The grill can comprise a handle for use by a user to rotate the grill between the first and second rotational positions.

The grill can comprise opposing grill plates movable between open and closed positions. The opposing grill plates can be hingedly connected for rotation about a hinge axis to effect movement between the open and closed positions. The hinge axis can be perpendicular to the rotational axis.

The waffle maker can further comprise a lock operable between a locked position, where the grill plates are maintained in the closed position, and an unlocked position, where the grill plates are free to move between the closed position and the open position. The grill can be rotatable about the rotational axis between a first and a second rotational position, where the lock is in the unlocked position when the grill is in at least one of the first and second rotational positions. The lock can be in the locked position for at least a portion of the rotation between the first and second rotational positions. Rotation of the grill between the first and second rotational positions can effect operation of the lock between the unlocked and locked positions.

The body centerline can pass through the center of gravity of the grill.

The rotational axis can pass through the center of gravity of the grill.

A waffle maker according to another aspect of the present invention comprises a base, a grill rotatably mounted to the base for rotation about a rotational axis and having opposing grill plates movable between open and closed positions and a lock operable between a locked position, where the grill plates are maintained in the closed position, and an unlocked position, where the grill plates are free to move between the closed position and the open position.

The grill can be rotatable about the rotational axis between a first and a second rotational position, where the lock is in the unlocked position when the grill is in at least one of the first and second rotational positions. The lock can be in the locked position for at least a portion of the rotation between the first and second rotational positions. Rotation of the grill between the first and second rotational positions can effect operation of the lock between the unlocked and locked positions.

### BRIEF DESCRIPTION OF THE DRAWINGS

In the drawings:

FIG. 1 is a front perspective view of a waffle maker according to the present invention, in a closed position.

FIG. 2 is a perspective view of the waffle maker from FIG. 1 in an open position.

FIG. 3 is a rear perspective view of the waffle maker from FIG. 1 in a closed position.

FIG. 4 is a top view of the waffle maker from FIG. 1.

FIG. 5 is a front view of the waffle maker from FIG. 1, illustrating the waffle maker in a first horizontal orientation.

FIG. 6 is a FIG. 5 is a front view of the waffle maker from FIG. 1, illustrating the waffle maker in an intermediate orientation.

FIG. 7 is a front view of the waffle maker from FIG. 1, illustrating the waffle maker in a second horizontal orientation.

FIG. 8 is a schematic view of a locking mechanism for the waffle maker, illustrating the locking mechanism in an unlocked position.

FIG. 9 is a schematic view of the locking mechanism from FIG. 9, illustrating the locking mechanism in a locked position.

FIG. 10 is a front view of a camming surface for the locking mechanism from FIG. 9.

### DESCRIPTION OF THE PREFERRED EMBODIMENT

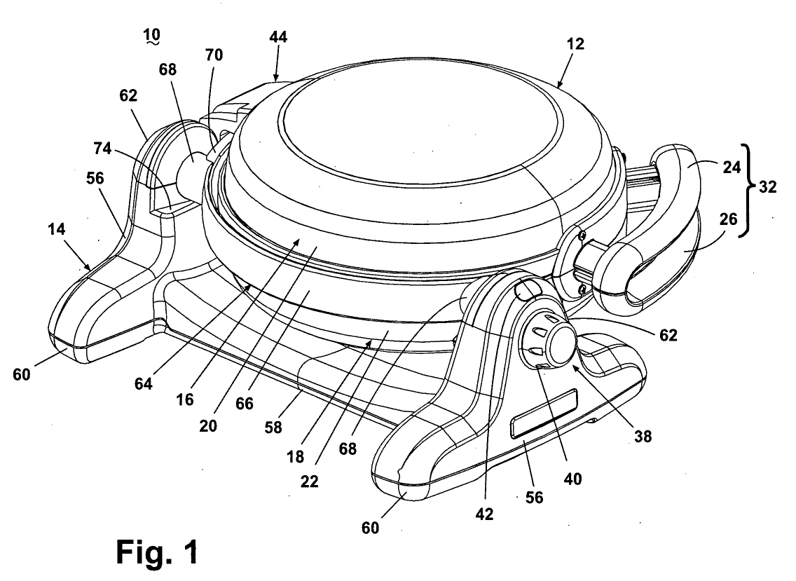

Referring to the drawings, and in particular to FIG. 1, an example of a waffle maker 10 according to the present invention is illustrated. While the invention referred to herein is applied to a waffle maker, it is understood that the invention can be applied to other types of cooking appliances having a rotating structure for two cooking positions.

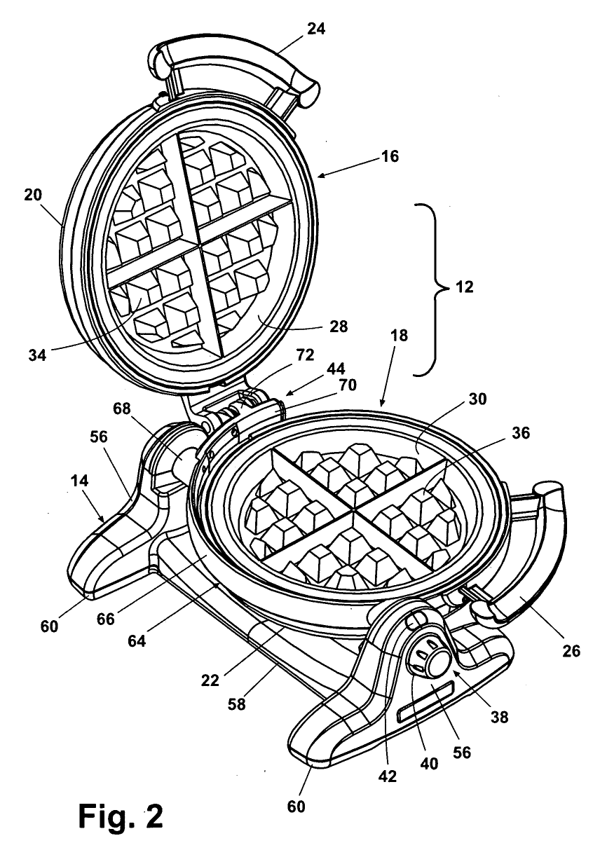

Referring to FIG. 2, the waffle maker 10 comprises a grill 12 rotatably mounted to and supported by a base 14. The grill 12 has opposing upper and lower grill plates 16, 18 that will conduct heat to a food item, such as a batter, received between the grill plates 16, 18 when the waffle maker 10 is connected to a source of electricity. Each grill plate 16, 18 typically comprises a housing 20, 22 with a hand grip 24, 26, and a cooking element 28, 30, respectively.

The housings 20, 22 can be made from a nonconducting or insulating material to prevent the outer surface of the housings 20, 22 from becoming dangerously hot due to the heat of the cooking elements 28, 30. Alternately, a separate insulator can be placed between the cooking elements 28, 30 and the housings 20, 22.

The hand grips 24, 26 are attached to the respective housing 20, 22 and collectively form a handle 32 when the grill plates 16, 18 are in the closed position shown in FIG. 1. The handle 32 allows the waffle maker 10 to be manipulated safely when hot, although other designs wherein only a single hand grip is provided is also possible. The hand grips 24, 26 can be attached to the housings 20, 22 via screws or other suitable fastening means.

The cooking elements 28, 30 are commonly made of a metal, such as iron or steel, and usually have a non-stick coating. Each cooking element 28, 30 has a cooking surface 34, 36, respectively, that can have a typical Belgian waffle pattern. The cooking elements 28, 30 are shown having a circular shape, although square and rectangular grill plates are also common, and a variety of other shapes, although less prevalent, could also be used. The cooking elements 28, 30 can also vary in size. An exemplary diameter of the circular cooking elements 28, 30 illustrated herein is 7″. The cooking elements 28, 30 can also be removable and replaceable with cooking elements having different cooking surface patterns and shapes.

The waffle maker 10 can be further provided with a user interface 38 to control and monitor the cooking of a waffle, as known to those skilled in the art, including setting the temperature of the grill plates 16, 18 at a temperature suitable for cooking a waffle, although in many embodiments the cooking temperature of the waffle maker 10 is fixed, and therefore this feature is accomplished by simply turning on the waffle maker 10. In the illustrative embodiment of the waffle maker 10, the user interface 38 is located on the base 14. An exemplary user interface 38 comprises a control knob 40 and an indicator light 42.

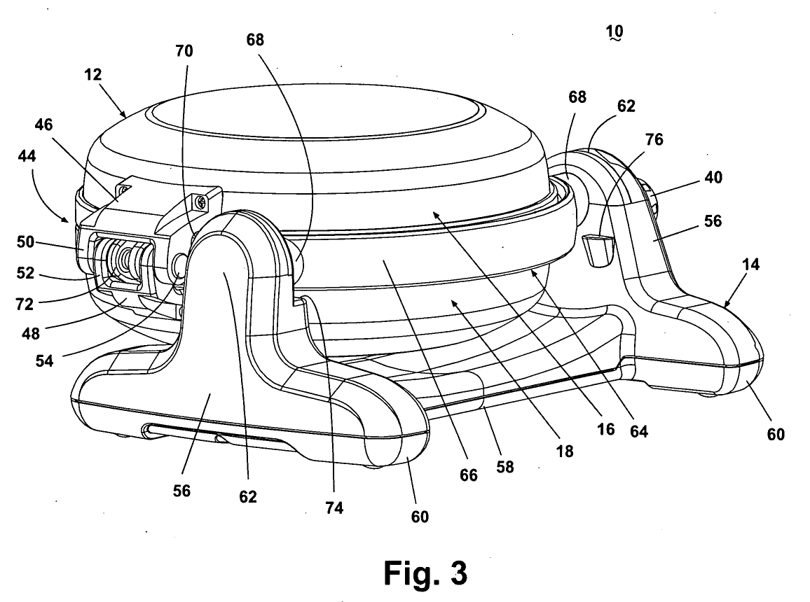

Referring to FIG. 3, the grill plates 16, 18 are pivotally connected to one another by a hinge assembly 44 such that the grill plate 16, 18 are movable between an open position (FIG. 2) and a closed position (FIGS. 1 and 3), where the one of the grill plates 16, 18 overlies the other in a well-known manner. In the closed position, the first grill plate 16 can overlie the second grill plate 18 or vice versa. The hinge assembly 44 comprises a first hinge portion 46 attached to the first housing 20 and a second hinge portion 48 attached to the second housing 22. The hinge portions 46, 48 can be attached to their respective housings 20, 22 via screws or other suitable fastening means. Each hinge portion 46, 48 has a respective pair of spaced knuckles 50, 52 for receiving one or more hinge pins 54. The knuckles 50 on the first hinge portion 46 are spaced farther apart than the knuckles 52 on the second hinge portion 48 so that the knuckles 52 can be received between the knuckles 50. The knuckles 50, 52 are aligned in opposing relation and are coupled with one another by at least one, and more preferably two, hinge pins 54 to form a pivoting joint between the hinge portions 46, 48.

The base 14 comprises a pair of spaced supports 56 joined by a cross-piece 58. Each support 56 is generally shaped as an inverted T, with a substantially horizontal portion 60 upon which the waffle maker 10 rests and a substantially vertical portion 62 extending generally upwardly from the horizontal portion 60. It is understood that other bases 14 with other configurations can be provided for the waffle maker 10.

A rotation yoke 64 is provided on the grill plate 12 and comprises a curved body 66 having a pair of aligned pivot arms 68 at or near opposing ends of the curved body 66. The curved body 66 is shaped to generally follow the perimeter shape of the grill 12 and can be spaced from the periphery of the grill 12. The pivot arms 68 extend in opposite directions away from each other and are rotatably received in rotation sockets (not shown) formed on an inner surface of the vertical portions 62, “inner” being defined as being toward the grill 12. The curved body 66 further comprises an attachment extension 70 that extends beyond one of the pivot arms 68, and is used to fixedly attach the rotation yoke 64 to the grill 12 to substantially prevent relative movement between the yoke 64 and grill 12. The extension 70 comprises a pair of spaced knuckles 72 that are received between the knuckles 52 on the second hinge portion 48 of the hinge assembly 44. The knuckles 72 are secured to the hinge assembly 44 with the same hinge pins 54 that couple the first and second hinge portions 46, 48.

A yoke stop 74 is formed on the inner surface of the vertical portion 62 nearest the extension 70 and generally comprises a ledge integrally formed in the base 14 that limits the rotation of the yoke 64 and consequently of the grill 12 by engaging the extension 70 of the yoke 74 when the grill 12 is in a horizontal orientation, as shown in FIGS. 1 and 3.

A pair of spaced grill supports 76 protrude from the inner surface of the other vertical portion 62 and are positioned generally lower than and to one side of the pivot arm 68 such that the grill 12 selectively rests on one of the grill supports 75 in the horizontal orientation. The grill supports 76 prevent the grill 12 from dropping lower than the rotation yoke 64 when the rotation yoke 64 is in the horizontal orientation with the extension 70 resting on the yoke stop 74.

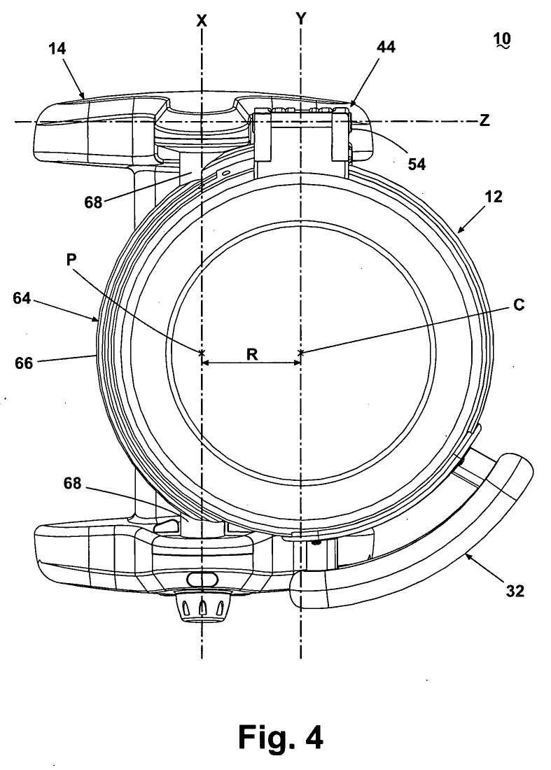

Referring to FIG. 4, the grill 12 comprises a body centerline Y. The body centerline Y is defined as a line extending along a plane passing through the grill 12 that divides the grill 12 into two halves. In the embodiment shown, the body centerline Y passes through a geometric center C of the grill 12 such that the two halves are generally equal in size. The body centerline Y can furthermore pass through the center of gravity of the grill 12. The center of gravity can, but does not always, coincide with the geometric center C. While a symmetrical grill 12 is illustrated herein, it is understood that an analogous body centerline Y can be applied to a non-symmetrical grill, where the body centerline Y extends along a plane that divides the grill into two halves that may or may not be equal in size, volume, and/or weight.

An axis of grill rotation (also referred to as rotational axis) X passes through the pivot arms 68 of the yoke 64 and defines the axis about which the grill 12 rotates relative to the base 14. At least one point P on the body centerline Y is radially offset from at least one point, illustrated herein as a point at the geometric center C of the grill 12, on the rotational axis X by a distance R. In the illustrated embodiment, the body centerline Y is parallel to the rotational axis X, although it is within the scope of the invention for the two lines to be nonparallel.

An axis of grill plate rotation Z passes through the hinge pin 54 of the hinge assembly 44 and defines the axis about which the grill plates 16, 18 rotate relative to one another. In the embodiment illustrated herein, the axis of grill plate rotation Z is substantially perpendicular to the rotational axis X and body centerline Y. Alternately, the axis of grill plate rotation Z can be perpendicular to one or neither of the rotational axis X and body centerline Y.

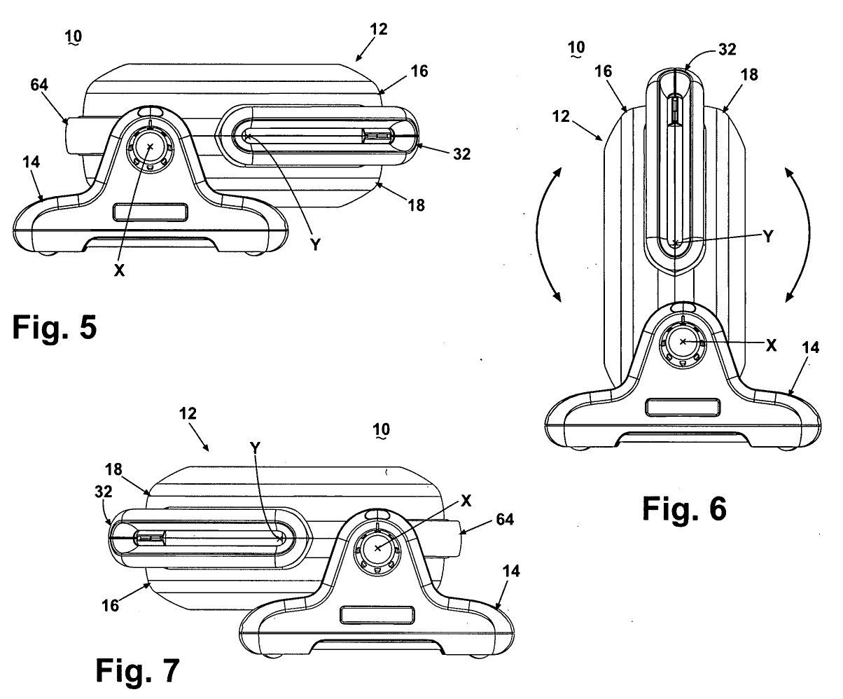

Referring to FIGS. 5-7, the waffle maker 10 is rotatable about the rotational axis X between a first position, illustrated in FIG. 5, and a second position, illustrated in FIG. 7. In the first position, the grill 12 is preferably in a generally horizontal orientation with respect to the surface on which the base 14 is resting, with the grill plate 16 overlying the grill plate 18. In the second position, the grill 12 is preferably in a generally horizontal orientation, with the grill plate 18 overlying the grill plate 16. To move the grill 12 from the first position to the second, a user grasps the handle 32 and rotates the grill 12 through a range of intermediate positions, including a generally vertical orientation shown in FIG. 6, to the second position. As can be seen, the body centerline Y of the grill 12 remains generally parallel to the rotational axis X throughout the range of motion between the first and second positions.

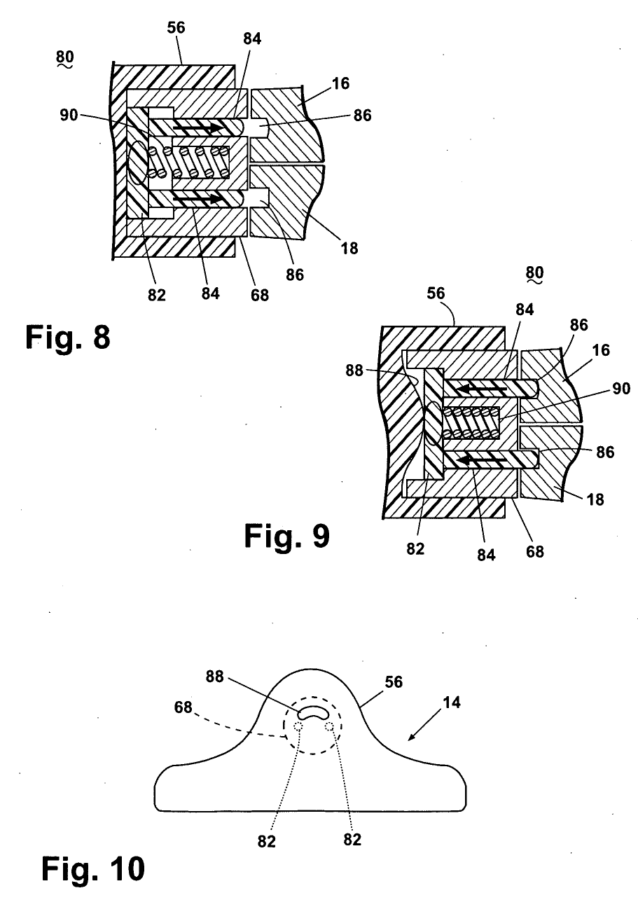

When rotating the grill 12 between the first and second positions, the grill plates 16, 18 can be held closed by the pressure of the user's hand on the two handle grips 24, 26 forming the handle 32. However, in some cases it might be desirable to provide a locking mechanism for maintaining the grill plates 16, 18 in the closed position while the grill 12 is rotating. Referring to FIG. 8-9, an exemplary locking mechanism 80 is schematically illustrated. It is understood that the size of elements of the locking mechanism are exaggerated from illustration purposes and are not drawn to scale or proportion. The exemplary locking mechanism 80 comprises a locking pin plate 82 having a pair of spaced locking pins 84 that are slidable within channels 86 extending through the pivot arm 68 of the rotation yoke 64 and partially into the grill plates 16, 18, and a camming surface 88 located on one of the supports 56. The locking pin plate 82 is rotatable with the pivot arm 68 so that it will correspondingly rotate when the grill 12 is rotated, such as during rotation of the grill 12 between the first and second positions (FIGS. 5 and 7, respectively). A spring 90 biases the locking pin plate 82 to the position shown in FIG. 8.

The locking mechanism 80 is operable between an unlocked position shown in FIG. 8 and a locked position shown in FIG. 9. In the unlocked position, the grill plates 16, 18 are free to move between the closed and open positions (FIGS. 1 and 2, respectively). In the locked position, the grill plates 16, 18 are maintained in the closed position and are prevented from moving to the open position. The operation of the locking mechanism 80 between the unlocked and locked positions is effected by rotation of the grill 12 (i.e. the grill plates 16, 18) with respect to the base 14 about the rotational axis X. Specifically, the locking mechanism 80 will be in the unlocked position (FIG. 8) when the waffle maker 10 is in the first or second position (FIGS. 5 and 7) and the locking mechanism 80 will be in the locked position (FIG. 9) when the waffle maker 10 is in an intermediate position, such as the intermediate position illustrated in FIG. 6.

The operation of the locking mechanism 80 will now be described with respect to FIGS. 8-10. As illustrated in FIG. 10, the locking pin plate 82 is schematically shown in phantom in each of the unlocked positions the waffle maker 10 can assume, i.e. in either the first or second position (FIGS. 5 and 7, respectively). Regardless of whether the waffle maker is in the first or second position, in the unlocked position, the locking pin plate 82 lies below the camming surface 88. The camming surface 88 protrudes from a portion of the support 56 such that the camming surface 88 contacts the locking pin plate 82 during at least a portion of the rotation of the grill 12 about the rotational axis X. The locking pin plate 82 can be spaced from the camming surface 88 such that the camming surface 88 will contact the locking pin plate 82 partway into the rotation of the grill 12. For example, the locking pin plate 82 can be configured to engage the camming surface 88 after the grill plate 12 rotates a small amount, such as 5-10° from the horizontal, for example. This ensures that the grill plates 16, 18 are unlocked in the horizontal positions and automatically locked during the rotation between the horizontal positions, which prevents the accidental opening of the grill plates 16, 18.

In rotation between the horizontal positions, the locking pin plate lies below the camming surface 88. As the grill plates are rotated by the user, the locking pin plate 82 comes into contact with the camming surface 88 causing the protruding camming surface 88 forces the locking pin plate 82 inwardly to the locked position shown in FIG. 9, “inwardly” being defined as being toward the grill plates 16, 18. Consequently, the locking pins 84 slide into the portion of the channels 86 that extends into the grill plates 16, 18 and the grill plates 16, 18 are thus prevented from opening. As the grill 12 is rotated to either the first or second position, the locking pin plate 82 is released from contact with the camming surface 88 and the spring 90 forces the locking pin plate 82 outwardly to the unlocked position shown in FIG. 8. Consequently, the locking pins 84 slide out of the portion of the channels 86 that extends into the grill plates 16, 18 and the grill plates 16, 18 are free to be opened.

The locking mechanism 80 need not be in the locked position during the entire period of rotation of the grill 12. For example, the locking mechanism 80 can be configured so that the locking pin plate 82 engages the camming surface 88 after a certain degree of movement. For example, the locking mechanism 80 can be automatically moved to the locked position after moving the grill 12 more than 15° from the horizontal orientation corresponding to the first and second positions. Thus the grill 12 can be moved up to 15 from the horizontal without the locking mechanism 80 being engaged.

The inventive waffle maker 10 offers improved baking performance by allowing the grill 12 to rotate substantially 180° with respect to the base 14 in a compact and non-bulky arrangement by offsetting the body centerline C of the grill 12 from the rotational axis X. Because the body centerline C is offset from the rotational axis X, a lower clearance is required to be able to rotate the grill 12 as compared with a waffle maker having the body centerline C and the rotational axis X collinear. The grill 12 can be placed closer to the base 14 because less that half of the diameter of the grill 12 must clear the space between the base 14 and the rotational axis X, thus providing a waffle maker 10 with a lower profile. The optional locking mechanism 80 provides added safety when rotating the grill 12 about the rotational axis X.

While the invention has been specifically described in connection with certain specific embodiments thereof, it is to be understood that this is by way of illustration and not of limitation, and the scope of the appended claims should be construed as broadly as the prior art will permit.

What is claimed is:

1. A waffle maker comprising:
a base; and
a grill having a body centerline and rotatably mounted to the base for rotation about a rotational axis;
wherein at least one point on the body centerline is radially offset from at least one point on the rotational axis.

2. The waffle maker according to claim 1 wherein the body centerline is parallel to the rotational axis.

3. The waffle maker according to claim 2 wherein the grill has a geometric centerline that is collinear with the body centerline.

4. The waffle maker according to claim 3 wherein the grill is rotatable about the rotational axis between a first and a second rotational position to define a range of motion.

5. The waffle maker according to claim 4 wherein the body centerline remains parallel to the rotational axis throughout the range of motion.

6. The waffle maker according to claim 5 wherein the grill is in a substantially horizontal orientation in the first and second rotational positions.

7. The waffle maker according to claim 1 wherein the grill is rotatable about the rotational axis between a first and a second rotational position.

8. The waffle maker according to claim 7 wherein the grill is in a substantially horizontal orientation in the first and second rotational positions.

9. The waffle maker according to claim 7 wherein the grill comprises a handle for use by a user to rotate the grill between the first and second rotational positions.

10. The waffle maker according to claim 1 wherein the grill comprises opposing grill plates movable between open and closed positions.

11. The waffle maker according to claim 10 wherein the opposing grill plates are hingedly connected for rotation about a hinge axis to effect movement between the open and closed positions.

12. The waffle maker according to claim 11 wherein the hinge axis is perpendicular to the rotational axis.

13. The waffle maker according to claim 11, further comprising a lock operable between a locked position, where the grill plates are maintained in the closed position, and an unlocked position, where the grill plates are free to move between the closed position and the open position.

14. The waffle maker according to claim 13 wherein the grill is rotatable about the rotational axis between a first and a second rotational position, where the lock is in the unlocked position when the grill is in at least one of the first and second rotational positions.

15. The waffle maker according to claim 14 wherein the lock is in the locked position for at least a portion of the rotation between the first and second rotational positions.

16. The waffle maker according to claim 15 wherein rotation of the grill between the first and second rotational positions effects operation of the lock between the unlocked and locked positions.

17. The waffle maker according to claim 1 wherein the body centerline passes through the center of gravity of the grill.

18. The waffle maker according to claim 1 wherein the rotational axis passes through the center of gravity of the grill.

19. A waffle maker comprising:
a base;
a grill rotatably mounted to the base for rotation about a rotational axis and having opposing grill plates movable between open and closed positions; and
a lock operable between a locked position, where the grill plates are maintained in the closed position, and an unlocked position, where the grill plates are free to move between the closed position and the open position.

20. The waffle maker according to claim 19 wherein the grill is rotatable about the rotational axis between a first and a second rotational position, where the lock is in the unlocked position when the grill is in at least one of the first and second rotational positions.

21. The waffle maker according to claim 20 wherein the lock is in the locked position for at least a portion of the rotation between the first and second rotational positions.

22. The waffle maker according to claim 21 wherein rotation of the grill between the first and second rotational positions effects operation of the lock between the unlocked and locked positions.
